(19) United States
(12) Patent Application Publication
(10) Pub. No.: US 2026/0264151 A1
(43) Pub. Date: Sep. 10, 2026

(54) ADDITIVE MANUFACTURING USING A PARTICLE BEAM

(71) Applicant: FREEMELT AB, MÖLNDAL (SE)

(72) Inventor: Ulf ACKELID, GÖTEBORG (SE)

(21) Appl. No.: 18/880,157

(22) PCT Filed: Jun. 29, 2023
(86) PCT No.: PCT/EP2023/067854

§ 371 Date: Dec. 30, 2024

(30) Foreign Application Priority Data
Jul. 1, 2022 (SE) 2250832-9

(51) Int. Cl. B22F 12/00; B22F 12/41; B22F 12/90; B33Y 30/00

(52) U.S. Cl. CPC B22F 12/38; B22F 12/41; B22F 12/90; B33Y 30/00

(57) ABSTRACT

In accordance with one or more embodiments herein, an additive manufacturing apparatus 100 is provided. The additive manufacturing apparatus 100 comprises a particle beam source 110, a build tank 150, a vacuum chamber 130, arranged to enclose the particle beam all the way from the particle beam source 110 to the build tank 150, one or more vacuum pumps 140, arranged to provide vacuum inside the vacuum chamber 130, and an X-ray shield 120, arranged to enclose at least the particle beam source 110, the vacuum chamber 130, and at least one of the one or more vacuum pumps 140. Further, a method 400 for constructing an additive manufacturing apparatus comprising a particle beam source 110 and a build tank 150 is provided. The method 400 comprises arranging 410 an X-ray shield 120 in an additive manufacturing apparatus 100, to enclose at least the particle beam source 110, a vacuum chamber 130 arranged to enclose the particle beam all the way from the particle beam source 110 to the build tank 150, and at least one vacuum pump 140 arranged to provide vacuum inside the vacuum chamber 130.

### TECHNICAL FIELD

The present disclosure relates generally to additive manufacturing using a particle beam.

### BACKGROUND

In additive manufacturing using a particle beam, such as e.g. Electron Beam Powder Bed Fusion (E-PBF), backscattered electrons and X-rays, so called primary X-rays, are generated from the powder bed. These backscattered electrons may collide with other surfaces and create even more X-rays, so called secondary X-rays. For the safety of operators of such an apparatus, it is necessary to arrange an X-ray shield that prevents operators of the apparatus from being exposed to the generated X-rays. Since additive manufacturing using a particle beam requires vacuum in order for the particle beam not to be diverted by hitting gas molecules on its way towards the build, the additive manufacturing apparatus typically comprises a vacuum chamber that encloses the particle beam all the way from the particle beam source to the build. The X-ray shield is typically integrated into the walls of the vacuum chamber of the additive manufacturing apparatus.

### PROBLEMS WITH THE PRIOR ART

When the X-ray shield is integrated into the walls of the vacuum chamber of the additive manufacturing apparatus, X-rays may leak through any openings in these walls. Since there must be openings for vacuum pumps, vacuum gauges, viewports and similar, it is difficult to create an X-ray shield that does not leak, especially since both the primary X-rays and the secondary X-rays must be considered. The X-ray shield must also be optimized to work with all materials to be manufactured in the additive manufacturing apparatus, since different materials produce different X-ray intensities.

There is thus a need for an additive manufacturing apparatus with improved X-ray shielding.

### SUMMARY

The above described problem is addressed by the claimed additive manufacturing apparatus. The apparatus may comprise: a particle beam source, a build tank, a vacuum chamber, arranged to enclose the particle beam all the way from the particle beam source to the build tank, one or more vacuum pumps, arranged to provide vacuum inside the vacuum chamber, and an X-ray shield, arranged to enclose at least the particle beam source, the vacuum chamber, and at least one of the one or more vacuum pumps.

The above described problem is further addressed by the claimed method for constructing an additive manufacturing apparatus comprising a particle beam source and a build tank. The method may comprise arranging an X-ray shield in an additive manufacturing apparatus, to enclose at least the particle beam source, a vacuum chamber arranged to enclose the particle beam all the way from the particle beam source to the build tank, and at least one vacuum pump arranged to provide vacuum inside the vacuum chamber.

This enables a simple creation of an X-ray shield that does not leak, by separating the X-ray shield from the walls of the vacuum chamber. The vacuum chamber does not have to be a chamber as such, it can simply be an enclosure made up of different parts that may be tightly connected to each other.

In embodiments, the X-ray shield is arranged to enclose also the build tank. This enables more parts of the additive manufacturing apparatus to be enclosed by the X-ray shield.

In embodiments, the X-ray shield is arranged to enclose also a powder tank comprised in the additive manufacturing apparatus. This enables all parts of the additive manufacturing apparatus to be enclosed by the X-ray shield.

In embodiments, the X-ray shield is arranged to comprise a door, and preferably also a door sensor which senses if the door is open. In embodiments, the particle beam source is arranged to be automatically turned off if the door sensor senses that the door is opened, and preferably remain disabled as long as the door remains open. This ensures that the particle beam source will not generate harmful X-rays when the door in the X-ray shield is open.

In embodiments, the door is arranged to be automatically locked as soon as the particle beam source is activated. This ensures that no one can enter inside the X-ray shield when the particle beam source generates harmful X-rays.

In embodiments, a people sensor is arranged on the inside of the X-ray shield, which people sensor senses the presence of people inside the X-ray shield. The people sensor may be any kind of sensor that is capable of detecting that there may be people present inside the X-ray shield, such as e.g. an IR camera.

In embodiments, the particle beam source is arranged to be automatically turned off if the people sensor senses the presence of people inside the X-ray shield. This ensures that the particle beam source will not generate harmful X-rays when there are people inside the X-ray shield. In embodiments, the particle beam source is arranged to remain disabled as long as the people sensor senses the presence of people inside the X-ray shield.

In embodiments, the particle beam source is an electron beam source, such as e.g. an electron gun.

In embodiments, a number of additive manufacturing apparatuses are arranged to form an additive manufacturing production facility. In embodiments, the X-ray shields surrounding these additive manufacturing apparatuses are arranged so that at least one X-ray shield wall is shared between at least two different additive manufacturing apparatuses. This is an efficient way of arranging an additive manufacturing production facility.

The above described problem is further addressed by the claimed additive manufacturing production facility comprising a number of the above additive manufacturing apparatuses, wherein at least one wall of the X-ray shield is shared between at least two different additive manufacturing apparatuses.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIGS. 1a-b schematically illustrate embodiments of an additive manufacturing apparatus, in accordance with one or more embodiments described herein.

FIG. 2 schematically illustrates an embodiment of an additive manufacturing apparatus, in accordance with one or more embodiments described herein.

FIG. 3 schematically illustrates an embodiment of an additive manufacturing production facility, in accordance with one or more embodiments described herein.

FIG. 4 schematically illustrates a method for additive manufacturing using a particle beam, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

In additive manufacturing using a particle beam, such as e.g. Electron Beam Powder Bed Fusion (E-PBF), backscattered electrons and X-rays, so called primary X-rays, are generated from the powder bed. These backscattered electrons may collide with other surfaces and create even more X-rays, so called secondary X-rays. For the safety of operators of such an apparatus, it is necessary to arrange an X-ray shield that prevents operators of the apparatus from being exposed to the generated X-rays. It is however difficult to design an additive manufacturing apparatus with X-ray shielding sufficient for a variety of processing conditions.

The wall thickness needed to shield X-rays is dependent on the acceleration voltage used in the particle beam source. A typical electron gun for an E-PBF system may e.g. have an acceleration voltage of 60 kV. The X-ray shielding efficiency of a material is essentially dependent on its atomic number. If the vacuum chamber is made of steel, steel walls of a thickness of 20 mm are needed to shield X-rays from a 60 kV electron gun. If the chamber walls are made of aluminum, the required wall thickness is much larger than 20 mm. A vacuum chamber with such a wall thickness becomes very heavy and expensive to manufacture. Thick walls also make it more difficult to get a good view into the additive manufacturing apparatus. Thicker walls means that larger viewports are needed in order to get the same angle of view into the chamber.

In addition, it is believed to be advantageous to develop E-PBF systems with higher acceleration voltage than 60 kV. For example, an acceleration voltage of 120 kV is believed to improve the E-PBF process in terms of energy efficiency, productivity, and robustness. However, for a 120 kV system, extremely thick steel walls are needed. Alternatively, high atomic number materials, such as e.g. tungsten or lead, may be attached on the outside of thinner steel walls. Such materials are expensive, and lead also has environmental issues. Furthermore, viewports would require extremely thick lead glass protection. Lead glass has poor optical properties, and thus it would be more difficult to use cameras and optical instruments to monitor and control the additive manufacturing process. In conclusion, X-ray shielding built into the vacuum chamber walls of an additive manufacturing apparatus with an acceleration voltage higher than 60 kV is technically very difficult, and also very costly.

An additive manufacturing apparatus with X-ray shielding at least partly separated from the walls of the vacuum chamber (which encloses the particle beam all the way from the particle beam source to the build) is therefore proposed. An at least partially separated X-ray shield can be made with low-cost material, and without some of the technical limitations associated with an X-ray shield that is integrated into the walls of the vacuum chamber of the additive manufacturing apparatus. An X-ray shield that is arranged to enclose at least the vacuum chamber, the particle beam source, and at least one vacuum pump arranged to provide vacuum inside the vacuum chamber, will create an X-ray barrier that is independent of any openings in the vacuum chamber walls. The vacuum chamber does not have to be a chamber as such, it can simply be an enclosure made up of different parts that may be tightly connected to each other.

An additive manufacturing apparatus may comprise a distance barrier, surrounding the whole additive manufacturing apparatus, in order to ensure that people cannot come too close to the additive manufacturing apparatus when it is operating. The X-ray shield may be integrated in, or become, such a distance barrier, instead of being integrated in the vacuum chamber walls. Such an X-ray shield will then also function as a barrier preventing people from coming too close to the additive manufacturing apparatus when it is operating. Since such an X-ray shield will be located further from the X-ray source, the X-ray shielding effect will also create an increased protection distance, since radiation levels decrease with increased distance from the source.

This concept enables the use of a vacuum chamber that is much simpler, since walls of a thickness of only a few millimeters is enough to ensure the mechanical stability of the vacuum chamber, if the vacuum chamber does not also have to shield against X-rays. This concept also means that it is not necessary to integrate X-ray shielding in viewports and feed-throughs to e.g. vacuum pumps.

The present disclosure relates generally to additive manufacturing apparatuses. Embodiments of the disclosed solution are presented in more detail in connection with the figures.

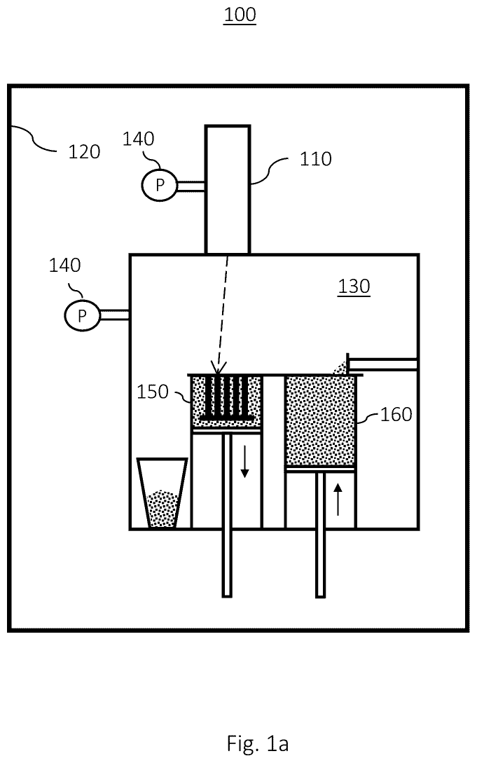

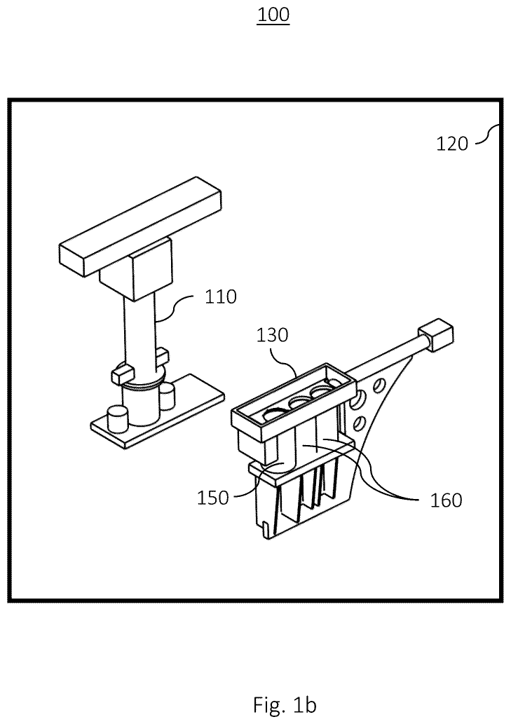

FIG. 1a schematically illustrates an embodiment of an additive manufacturing apparatus 100. The illustrated additive manufacturing apparatus 100 comprises a particle beam source 110, two vacuum pumps 140, arranged to provide vacuum inside the vacuum chamber 130, a build tank 150, a powder tank 160, and a vacuum chamber 130, arranged to enclose the particle beam all the way from the particle beam source 110 to the build tank 150. The illustrated additive manufacturing apparatus 100 further comprises an X-ray shield 120, arranged to enclose at least the electron beam source 110, the vacuum chamber 130, and the vacuum pumps 140. In the embodiment schematically illustrated in FIG. 1a, the X-ray shield 120 encloses also the build tank 150 and the powder tank 160, which in the illustrated embodiment are located inside the vacuum chamber 130. This enables all parts of the additive manufacturing apparatus to be enclosed by the X-ray shield 120.

FIG. 1b schematically illustrates another embodiment of an additive manufacturing apparatus 100. The illustrated additive manufacturing apparatus 100 comprises a particle beam source 110, a build tank 150, two powder tanks 160, and a vacuum chamber 130, arranged to enclose the particle beam all the way from the particle beam source 110 to the build tank 150. The illustrated additive manufacturing apparatus 100 further comprises an X-ray shield 120, arranged to enclose at least the electron beam source 110, the vacuum chamber 130, and the vacuum pumps 140 (not shown in FIG. 1b). In the embodiment schematically illustrated in FIG. 1b, the X-ray shield 120 encloses also the build tank 150 and the powder tank 160, which in the illustrated embodiment are located inside the vacuum chamber 130. This enables all parts of the additive manufacturing apparatus to be enclosed by the X-ray shield 120. In the embodiment schematically illustrated in FIG. 1b, the vacuum chamber 130 is not a chamber as such, it is simply an enclosure that is created when the different parts of the additive manufacturing apparatus 100 are tightly connected to each other.

The additive manufacturing apparatus 100 may comprise a plurality of vacuum pumps that are connected to each other. If a very high vacuum is required, the vacuum pump 140 that provides vacuum to the vacuum chamber 130 may be connected to an additional vacuum pump, which delivers a “prevacuum” to the vacuum pump 140. Such an additional vacuum pump does not have to be enclosed by the X-ray shield 130.

The particle beam source 110 may be any type of particle beam source, such as e.g. an electron gun. The particle beam source 110 may be enclosed in the vacuum chamber 130, or attached to the vacuum chamber 130 with an opening for the particle beam, as schematically illustrated in FIG. 1. In any case, it is an advantage if there is the same approximate vacuum level in both the particle beam source 110 and the vacuum chamber 130.

There are often feed-throughs or other openings in the vacuum chamber 130 also for other equipment than vacuum pumps 140, such as e.g. for one or more thermocouples. In order to control the pressure in the vacuum chamber 130, one or more pressure sensors may be used, and this may require one or more openings in the vacuum chamber 130 for such pressure sensors. There may also be other types of openings, such as e.g. viewports and/or openings for lights. It is advantageous if the X-ray shield 120 encloses all equipment that is connected to openings in the vacuum chamber 130, so that there is no need for any openings in the X-ray shield 120.

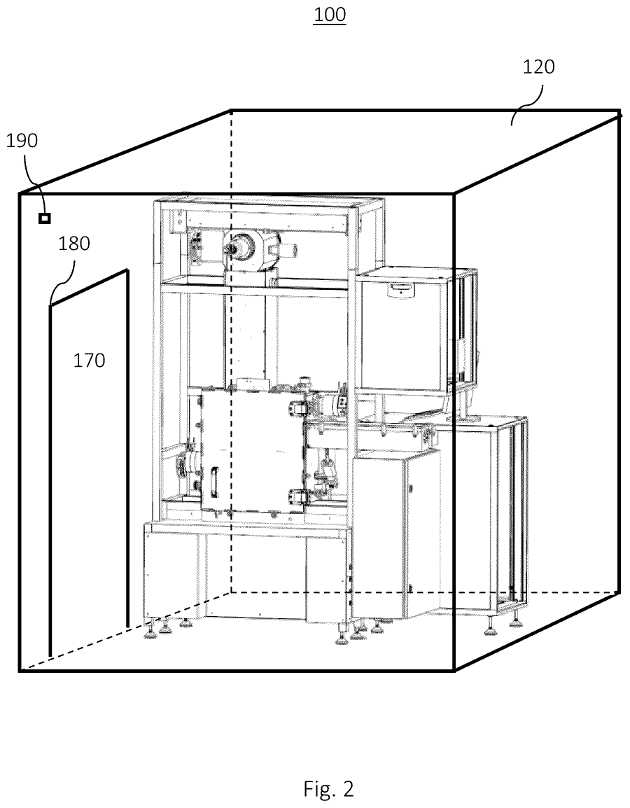

The X-ray shield 120 may in embodiments be arranged to enclose the whole additive manufacturing apparatus 100, e.g. in the form of walls that comprise a thin layer of lead. Such an X-ray shield is preferably configured so that it independently protects the surrounding environment from X-rays from the additive manufacturing apparatus 100, even if e.g. the vacuum chamber 130 will contribute to the protection. FIG. 2 schematically illustrates such an embodiment of an additive manufacturing apparatus, specifically an E-PBF apparatus, 100. In this embodiment, the X-ray shield 120 allows an operator to access the additive manufacturing apparatus 100 by opening a door 170 in the X-ray shield 120 and entering into the space between the X-ray shield 120 and the rest of the additive manufacturing apparatus 100.

It is in such embodiments an advantage if means are provided to ensure that the particle beam source 110 in the additive manufacturing apparatus 100 is automatically turned off if the door 170 would be opened when the additive manufacturing apparatus 100 is still running. This ensures that the particle beam source 110 will not generate harmful X-rays when the door 170 in the X-ray shield 120 is open. The additive manufacturing apparatus 100 may e.g. comprise a door sensor 180 which senses if the door 170 is open. In embodiments, the particle beam source 110 is arranged to be automatically turned off, and not be possible to turn on, if the door sensor 180 senses that the door 170 is opened. In embodiments, the door 170 is arranged to be automatically locked as soon as the particle beam source 110 is activated. This ensures that no one can enter inside the X-ray shield 120 when the particle beam source 110 generates harmful X-rays.

However, normally the operator would only enter the space between the X-ray shield 120 and the rest of the additive manufacturing apparatus 100 in order to remove a build from the build tank 150 and refill the powder tank 160, and thus the particle beam source 110 in the additive manufacturing apparatus 100 would not normally be running when the operator opens the door 170 in the X-ray shield 120. The operator would control the additive manufacturing apparatus 100 using e.g. cameras and sensors mounted inside the additive manufacturing apparatus 100, e.g. in the space between the X-ray shield 120 and the rest of the additive manufacturing apparatus 100.

In embodiments, a people sensor 190 is arranged on the inside of the X-ray shield 120. The people sensor 190 may be arranged to sense the presence of people inside the X-ray shield 120. The people sensor 190 may be any kind of sensor that is capable of detecting that there may be people present inside the X-ray shield 120, such as e.g. an IR camera.

In embodiments, the particle beam source 110 is arranged to be automatically turned off if the people sensor 190 senses the presence of people inside the X-ray shield 120. This ensures that the particle beam source 110 will not generate harmful X-rays when there are people inside the X-ray shield 120. In embodiments, the particle beam source 110 is arranged to remain disabled as long as the people sensor 190 senses the presence of people inside the X-ray shield 120.

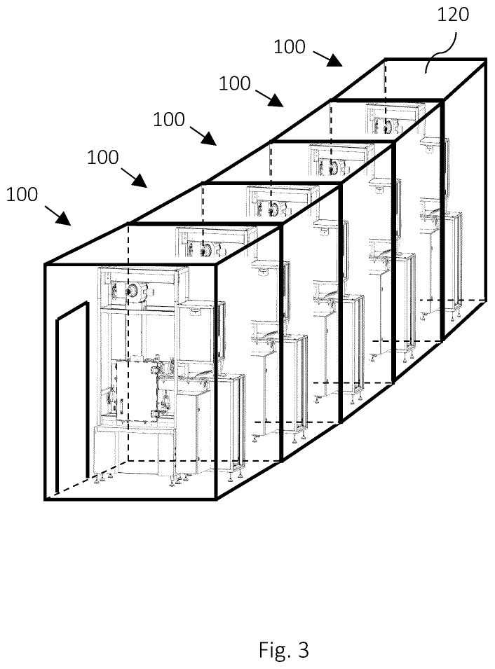

An additive manufacturing production facility may comprise a number of different additive manufacturing apparatuses 100 arranged next to each other. FIG. 3 schematically illustrates an embodiment of such an additive manufacturing production facility, where the additive manufacturing apparatuses 100 are arranged in different cells, where each cell is surrounded by an X-ray shield 120. For efficiency, the cells may share some of the walls of the X-ray shield 120. However, it is preferred if each cell contains a door 170 that can be opened independently of the doors 170 in the other cells, so that each additive manufacturing apparatus 100 may be serviced independently of the others.

The X-ray shield 120 may be manufactured from many different materials, such as e.g. metal, concrete, plaster or stone, as long as it is thick enough to prevent X-rays from propagating through the X-ray shield 120.

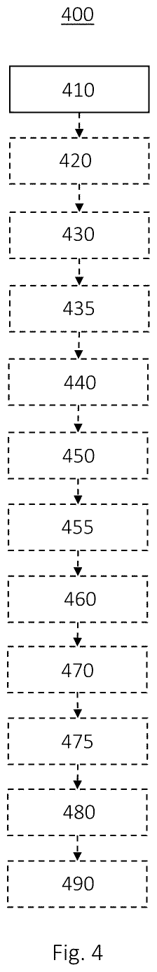

FIG. 4 schematically illustrates a method 400 for constructing an additive manufacturing apparatus 100 comprising a particle beam source 110 and a build tank 150. The method 400 may comprise:
Step 410: arranging an X-ray shield 120 in an additive manufacturing apparatus 100, to enclose at least the particle beam source 110, a vacuum chamber 130 arranged to enclose the particle beam all the way from the particle beam source 110 to the build tank 150, and at least one vacuum pump 140 arranged to provide vacuum inside the vacuum chamber 130.

This enables a simple creation of an X-ray shield 120 that does not leak, by separating the X-ray shield 120 from the walls of the vacuum chamber 130. The vacuum chamber 130 does not have to be a chamber as such, it can simply be an enclosure made up of different parts that may be tightly connected to each other.

The method 400 may further comprise one or more of:
Step 420: using an electron beam source, such as e.g. an electron gun, as the particle beam source 110.
Step 430: arranging the X-ray shield 120 to enclose also the build tank 150. This enables more parts of the additive manufacturing apparatus 100 to be enclosed by the X-ray shield 120.
Step 435: arranging the X-ray shield 120 to enclose also a powder tank 160 comprised in the additive manufacturing apparatus 100. This enables all parts of the additive manufacturing apparatus 100 to be enclosed by the X-ray shield 120.
Step 440: arranging the X-ray shield 120 to comprise a door 170.
Step 450: arranging the X-ray shield 120 to comprise a door sensor 180 which senses if the door 170 is open.
Step 455: arranging the particle beam source 110 to be automatically turned off if the door sensor 180 senses that the door 170 is opened. This ensures that the particle beam source 110 will not generate harmful X-rays when the door 170 in the X-ray shield 120 is open.
Step 460: arranging the door 170 to be automatically locked as soon as the particle beam source 110 is activated. This ensures that no one can enter inside the X-ray shield 120 when the particle beam source 110 generates harmful X-rays.
Step 470: arranging a people sensor 190 on the inside of the X-ray shield 120, which people sensor 190 senses the presence of people inside the X-ray shield 120. The people sensor 190 may be any kind of sensor that is capable of detecting that there may be people present inside the X-ray shield 120, such as e.g. an IR camera.
Step 475: arranging the particle beam source 110 to be automatically turned off if the people sensor 190 senses the presence of people inside the X-ray shield 120. This ensures that the particle beam source 110 will not generate harmful X-rays when there are people inside the X-ray shield 120.
Step 480: arranging a number of additive manufacturing apparatuses 100 to form an additive manufacturing production facility.
Step 490: arranging the X-ray shields 120 surrounding the additive manufacturing apparatuses 100 so that at least one X-ray shield wall is shared between at least two additive manufacturing apparatuses 100. This is an efficient way of arranging an additive manufacturing production facility.

The above steps may be effected in any order that makes technical sense, and some of the steps may be effected simultaneously with each other.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

1. An additive manufacturing apparatus comprising:
a particle beam source;
a build tank;
a vacuum chamber, arranged to enclose the particle beam all the way from the particle beam source to the build tank;
one or more vacuum pumps, arranged to provide vacuum inside the vacuum chamber; and
an X-ray shield, arranged to enclose at least the particle beam source, the vacuum chamber, and at least one of the one or more vacuum pumps.

2. The additive manufacturing apparatus according to claim 1, wherein the X-ray shield encloses also the build tank.

3. The additive manufacturing apparatus according to claim 2, further comprising a powder tank, wherein the X-ray shield encloses also the powder tank.

4. The additive manufacturing apparatus according to claim 1, wherein the X-ray shield comprises a door.

5. The additive manufacturing apparatus according to claim 4, further comprising a door sensor which senses if the door is open, wherein the particle beam source is arranged to be automatically turned off if the door sensor senses that the door is opened.

6. The additive manufacturing apparatus according to claim 5, wherein the particle beam source is arranged to remain disabled as long as the door sensor senses that the door remains open.

7. The additive manufacturing apparatus according to claim 4, wherein the door is arranged to be automatically locked as soon as the particle beam source is activated.

8. The additive manufacturing apparatus according to claim 1, further comprising a people sensor on the inside of the X-ray shield, which people sensor senses the presence of people inside the X-ray shield, wherein the particle beam source is arranged to be automatically turned off if the people sensor senses the presence of people inside the X-ray shield.

9. The additive manufacturing apparatus according to claim 8, wherein the particle beam source is arranged to remain disabled as long as the people sensor senses the presence of people inside the X-ray shield.

10. The additive manufacturing apparatus according to claim 1, wherein the particle beam source is an electron beam source.

11. An additive manufacturing production facility comprising a number of additive manufacturing apparatuses, each according to claim 1, wherein at least one wall of the X-ray shield is shared between at least two different additive manufacturing apparatuses.

12. A method for constructing an additive manufacturing apparatus comprising a particle beam source and a build tank, the method comprising arranging an X-ray shield in an additive manufacturing apparatus, to enclose at least the particle beam source, a vacuum chamber arranged to enclose the particle beam all the way from the particle beam source to the build tank, and at least one vacuum pump arranged to provide vacuum inside the vacuum chamber.

13. The method according to claim 12, further comprising arranging the X-ray shield to enclose also the build tank.

14. The method according to claim 13, further comprising arranging the X-ray shield to enclose also a powder tank comprised in the additive manufacturing apparatus.

15. The method according to claim 12, further comprising arranging the X-ray shield to comprise a door.

16. The method according to claim 15, further comprising arranging the X-ray shield to comprise a door sensor which senses if the door is open, and arranging the particle beam source to be automatically turned off if the door sensor senses that the door is opened.

17. The method according to claim 16, wherein the arranging of the particle beam source to be automatically turned off if the door sensor senses that the door is open comprises arranging the particle beam source to remain disabled as long as the door sensor senses that the door remains open.

18. The method according to claim 15, further comprising arranging the door to be automatically locked as soon as the particle beam source is activated.

19. The method according to claim 12, further comprising arranging a people sensor on the inside of the X-ray shield, which people sensor senses the presence of people inside the X-ray shield, and arranging the particle beam source to be automatically turned off if the people sensor senses the presence of people inside the X-ray shield.

20. The method according to claim 19, wherein the arranging of the particle beam source to be automatically turned off if the people sensor senses the presence of people inside the X-ray shield comprises arranging the particle beam source to remain disabled as long as the people sensor senses the presence of people inside the X-ray shield.

21. The method according to claim 12, further comprising using an electron beam source as the particle beam source.

22. The method according to claim 12, further comprising arranging a number of additive manufacturing apparatuses to form an additive manufacturing production facility, and arranging the X-ray shields surrounding said additive manufacturing apparatuses so that at least one X-ray shield wall is shared between at least two different additive manufacturing apparatuses.
